(19) United States
(12) Patent Application Publication
(10) Pub. No.: US 2023/0275833 A1
(43) Pub. Date: Aug. 31, 2023

(54) METHOD AND APPARATUS FOR CONFIGURING SOFTWARE-DEFINED WIDE AREA NETWORK IN COMMUNICATION SYSTEM

(71) Applicant: Samsung Electronics Co., Ltd., Suwon-si (KR)

(72) Inventors: Dowon HYUN, Suwon-si (KR); Seunghoon PARK, Suwon-si (KR); Jaijin LIM, Suwon-si (KR)

(21) Appl. No.: 18/313,743

(22) Filed: May 8, 2023

Related U.S. Application Data
(63) Continuation of application No. PCT/KR2021/016444, filed on Nov. 11, 2021.

(30) Foreign Application Priority Data
Nov. 16, 2020 (KR) 10-2020-0153201

(51) Int. Cl. H04L 45/74; H04L 45/302

(52) U.S. Cl. CPC H04L 45/74; H04L 45/302

(57) ABSTRACT

The disclosure relates to a 5^{th} generation (5G) or pre-5G communication system for supporting a higher data transmission rate beyond-4^{th} generation (4G) communication system such as long-term evolution (LTE). The disclosure relates to a method performed by a first network node in a communication system. The method includes the operations of receiving a packet from a user plane function (UPF), identifying a path of a data network on the basis of information included in the packet, and transmitting the packet through the path of the data network.

### CROSS-REFERENCE TO RELATED APPLICATION(S)

This application is a continuation application, claiming priority under § 365(c), of an International application No. PCT/KR2021/016444, filed on Nov. 11, 2021, which is based on and claims the benefit of a Korean patent application number 10-2020-0153201, filed on Nov. 16, 2020, in the Korean Intellectual Property Office, the disclosure of which is incorporated by reference herein in its entirety.

### BACKGROUND

### 1. Field

The disclosure relates to communication systems. More particularly, the disclosure relates to a method and apparatus for configuring a software defined wide area network (SD-WAN).

### 2. Description of Related Art

Efforts are being made to develop an improved 5th generation (5G) communication system or a pre-5G communication system in order to meet the growing demand for wireless data traffic after the commercialization of a 4th generation (4G) communication system. For this reason, the 5G communication system or pre-5G communication system is called a beyond 4G network communication system or a post long term evolution (LTE) system.

In order to achieve a high data rate, the 5G communication system is being considered for implementation in a millimeter wave (mmWave) band (e.g., a 60 Giga Hertz (GHz) band). In order to mitigate a path loss of radio waves and increase a propagation distance of radio waves in an ultra-high frequency band, beamforming, massive multiple input multiple output (MIMO), full dimensional multiple input multiple output (FD-MIMO), array antenna, analog beamforming, and large scale antenna technologies are being discussed in the 5G communication system.

Also, to improve a system network, in the 5G communication system, technologies such as an evolved small cell, an advanced small cell, a cloud radio access network (cloud RAN), an ultra-dense network, device to device communication (D2D), wireless backhaul, moving network, cooperative communication, coordinated multi-points (CoMP), and reception interference cancellation, etc. are being developed.

In addition, in the 5G system, advanced coding modulation (ACM) schemes such as hybrid frequency shift keying and quadrature amplitude modulation (FQAM) and sliding window superposition coding (SWSC), and advanced access technologies such as filter bank multi carrier (FBMC), non-orthogonal multiple access (NOMA), and sparse code multiple access (SCMA), etc. are being developed.

To guarantee a service level agreement (SLA) of an application, network slicing is used in a wireless network such as 4G/5G, and a software defined wide area network (SD-WAN) is used in a data network such as the Internet. However, in the case of network slicing, since the data network connected to the wireless network is generally an Internet network, it is difficult to guarantee the SLA in the data network. Also, in the case of SD-WAN, since the wireless network such as 4G/5G is considered as one connection, it is difficult to guarantee the SLA in the wireless network. Therefore, there is a need to interlock the network slicing and the SD-WAN in order to guarantee a true end-to-end SLA.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an apparatus and method for interlocking network slicing and a software defined wide area network (SD-WAN) in a communication system.

Additional aspects will be set forth in part in the description which follows and, in part, will be apparent from the description, or may be learned by practice of the presented embodiments.

In accordance with an aspect of the disclosure, a method performed by a first network node in a communication system is provided. The method includes the operations of receiving a packet from a user plane function (UPF), identifying a path of a data network, based on information included in the packet, and transmitting the packet through the path of the data network.

In accordance with another aspect of the disclosure, a method performed by a second network node in a communication system is provided. The method includes the operations of receiving a packet from a device, identifying an application of the received packet, identifying a slice through which the identified application is to be transmitted, and transmitting the packet through the identified slice.

In accordance with another aspect of the disclosure, a first network node in a communication system is provided. The first network node includes at least one transceiver and at least one processor operatively connected to the at least one transceiver. The at least one processor may be configured to receive a packet from a user plane function (UPF), identify a path of a data network, based on information included in the packet, and transmit the packet through the path of the data network.

In accordance with another aspect of the disclosure, a second network node in a communication system is provided. The second network node includes at least one transceiver and at least one processor operably connected to the at least one transceiver. The at least one processor may be configured to receive a packet from a device, identify an application of the received packet, identify a slice through which the identified application is to be transmitted, and transmit the packet through the identified slice.

A method and apparatus of embodiments of the disclosure may provide end-to-end service level agreement (SLA) and security, by interlocking network slicing and a software defined wide area network (SD-WAN) in a communication system.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a network structure according to an embodiment of the disclosure;

FIG. 2A illustrates a network structure for configuring a software defined wide area network (SD-WAN) according to an embodiment of the disclosure;

FIG. 2B illustrates a network structure for configuring an SD-WAN according to an embodiment of the disclosure;

FIG. 2C illustrates a network structure for configuring an SD-WAN according to an embodiment of the disclosure;

FIG. 2D illustrates a network structure for configuring an SD-WAN according to an embodiment of the disclosure;

FIG. 2E illustrates a network structure for configuring an SD-WAN according to an embodiment of the disclosure;

FIG. 3 illustrates a connection structure between a user plane function (UPF) and slices according to an embodiment of the disclosure;

FIG. 4 illustrates a signal flow between network nodes for network control according to an embodiment of the disclosure;

FIGS. 5A, 5B, and 5C illustrate a construction of a packet according to various embodiments of the disclosure;

FIGS. 6A, 6B, and 6C illustrate a structure of an integrated controller for network control according to various embodiments of the disclosure;

FIG. 7 illustrates a construction of an SD-WAN device according to an embodiment of the disclosure; and

FIG. 8 illustrates a construction of a network node according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

Terms and words used in the in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Terms used herein, including technical or scientific terms, may have the same meaning as those commonly understood by a person having an ordinary skill in the art described in the disclosure. Among the terms used in the disclosure, terms defined in general dictionaries may be interpreted as having the same or similar meanings as those in the context of the related art, and unless explicitly defined in the disclosure, are not be interpreted as ideal or excessively formal meanings. In some cases, even terms defined in the disclosure may not be interpreted to exclude embodiments of the disclosure.

Also, in the disclosure, an expression of exceed or less than has been used to determine whether a specific condition is satisfied or fulfilled, but this is only a description for expressing an example, and does not to exclude a description of equal to or more than, or equal to or less than. A condition described as ‘equal to or more than’ may be replaced with ‘exceed’, and a condition described as ‘equal to or less than’ may be replaced with ‘less than’, and a condition described as ‘equal to or more than, and less than’ may be replaced with ‘exceed, and equal to or less than’.

Also, in the disclosure, various embodiments are described using terms used in some communication standards (e.g., long term evolution (LTE) and new radio (NR) defined in 3rd generation partnership project (3GPP)), but this is just an example for explanation. Various embodiments of the disclosure may be easily modified and applied to other communication systems.

Hereinafter, the disclosure relates to a method and apparatus for configuring a software defined wide area network (SD-WAN) in a wireless communication system. Specifically, the disclosure describes a technology for interlocking network slicing and an SD-WAN, in order to service level agreement (SLA) and security required for each application, device, user, or company.

The definition of terms used in the disclosure is as follows.

‘Network slicing’ denotes a technology of presenting a dedicated network specialized for each of various services having different characteristics by providing several networks that are logically separated from a wireless network. That is, since each of network slices is guaranteed a virtualized network resource, errors or failures in a specific slice do not affect communication of other slices. For example, a slice supporting a high throughput is allocated to packets related to an enhanced mobile broadband (eMBB) application, and a slice supporting a low latency is allocated to packets related to an ultra reliable low latency communications (URLLC) application, and each slice does not affect each other.

A ‘software defined wide area network (SD-WAN)’ is a concept that extends a software defined network (SDN) to a WAN environment, and denotes a technology that configures an overlay network in a data network. The SD-WAN presents multiple connectivity in the data network to compensate for the problems of legacy WANs. In other words, the SD-WAN guarantees a quality by transmitting packets on a network satisfying a service level agreement (SLA) set by users among networks (e.g., the Internet, and multiprotocol label switching (MPLS)) presented by various communication providers, and presents a security by encrypting and transmitting traffic between SD-WAN customer premise equipment (CPEs) to an Internet protocol security (IPsec) tunnel.

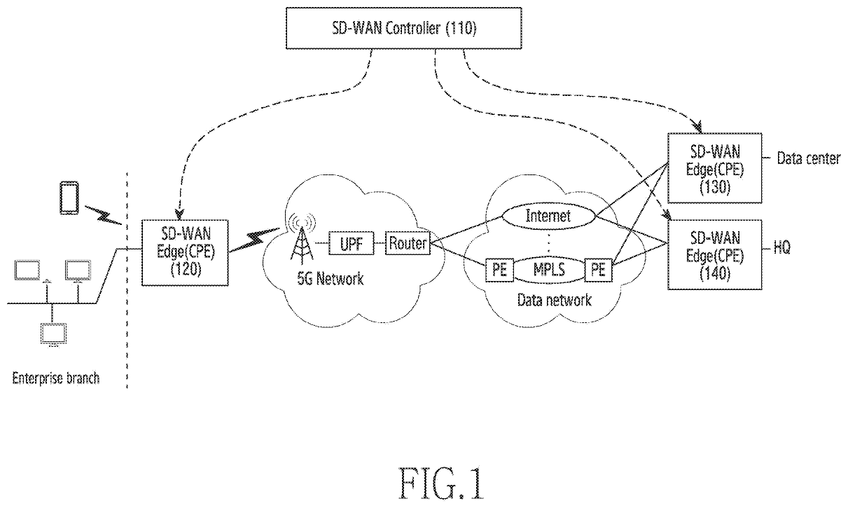

FIG. 1 illustrates a structure of a network according to an embodiment of the disclosure. FIG. 1 illustrates a software defined wide area network (SD-WAN) controller and SD-WAN edges as part of network nodes.

Referring to FIG. 1, an SD-WAN controller 110 may set a policy on SD-WAN edges 120, 130 and 140. According to an embodiment, the SD-WAN controller 110 may set a path through which packets are transmitted for each application, to the SD-WAN edges 120, 130 and 140. For example, the SD-WAN controller 110 may configure the SD-WAN edges 120, 130 and 140 wherein voice over Internet protocol (VoIP) packets in a data network are transmitted through multiprotocol label switching (MPLS) and data packets are transmitted through the Internet. According to an embodiment, the SD-WAN controller 110 may set the SD-WAN edges 120, 130 and 140 to change a path of application packets, based on network conditions. This may be referred to as dynamic path control (DPC). For example, the SD-WAN controller 110 specifies a DPC and low-loss policy for VoIP to the SD-WAN edges 120, 130 and 140 wherein VoIP packets may be transmitted through the Internet or the MPLS, based on a packet loss quality. According to an embodiment, the SD-WAN controller 110 may set the SD-WAN edges 120, 130 and 140 wherein application packets are transmitted using a plurality of paths. This may be referred to as tunnel bonding. For example, the SD-WAN controller 110 may allow transmission of packets belonging to a file transport protocol (FTP) flow to the SD-WAN edges 120, 130 and 140 through the Internet or MPLS by the unit of packet. That is, by load balancing packets belonging to one flow to several paths, a network bandwidth may be maximally utilized. However, since the order of packets may change as a result of being transmitted through the several paths, the SD-WAN controller 110 may set the SD-WAN edge 130 to restore the order. This may be referred to as packet order correction (POC). According to an embodiment, the SD-WAN controller 110 may allow the SD-WAN edges 120, 130 and 140 to insert forward error control (FEC) packets in order to recover a packet loss in the Internet. That is, the FEC packets may be inserted into application packets and transmitted, thereby stopping transmission control protocol (TCP) retransmission and preventing a decrease of a throughput. In this case, the FEC packet may be transmitted through the Internet, but may also be transmitted through another network (e.g., MPLS).

Referring to FIG. 1, the SD-WAN technology may satisfy a required SLA, such as specifying a path in a data network. However, since the SD-WAN technology regards a wireless network as a simple one connection only, it cannot satisfy an SLA in the wireless network. Also, a UPF may transmit packets only through a path (Internet or MPLS) set through a router. Therefore, there is a need to satisfy an end-to-end SLA, by interlocking with network slicing used for SLA satisfaction in the wireless network, and making possible path selection in the data network.

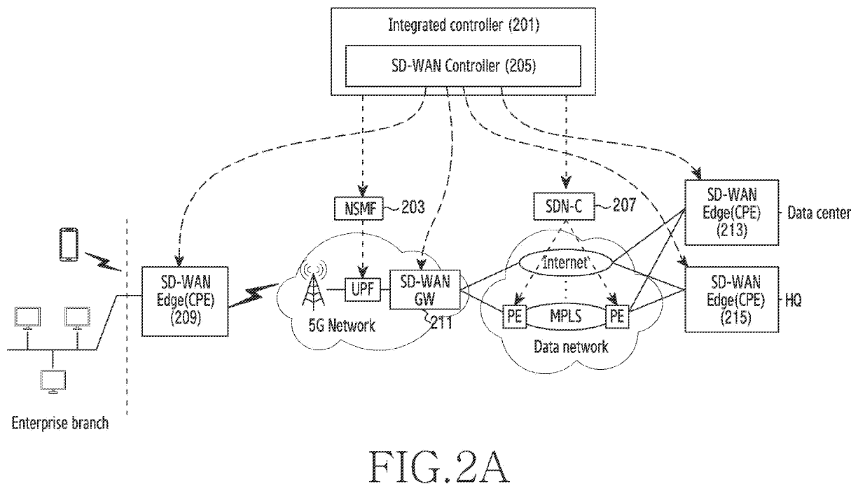

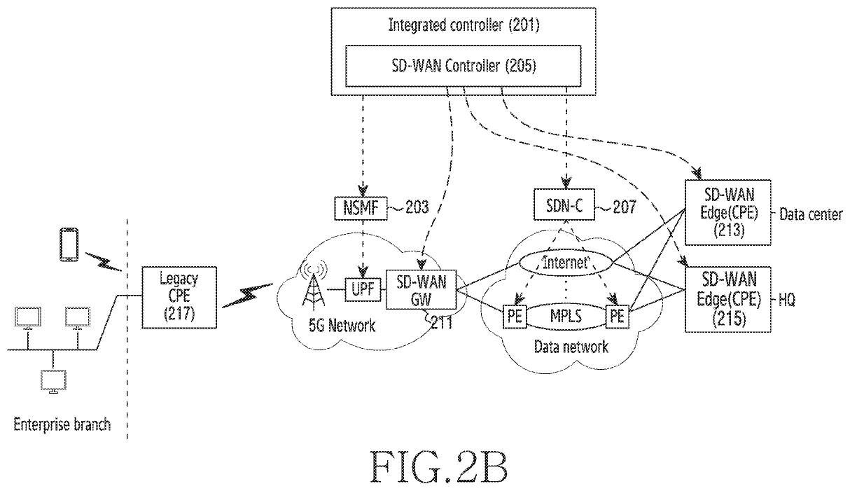

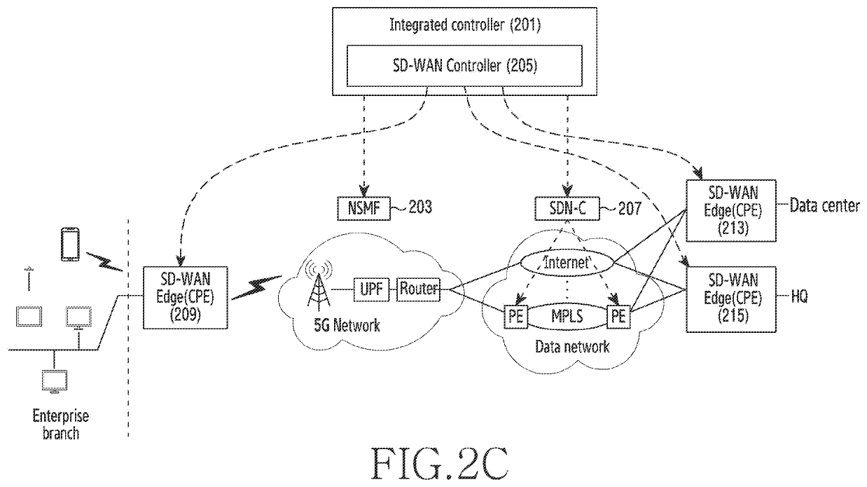

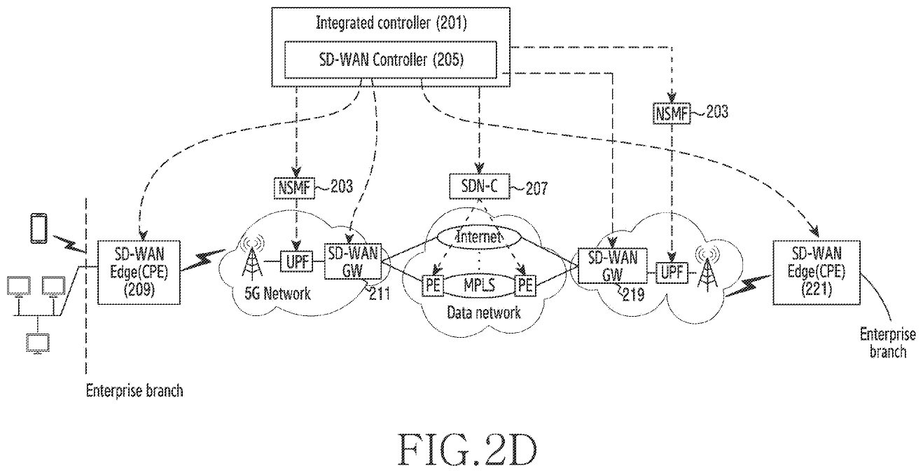

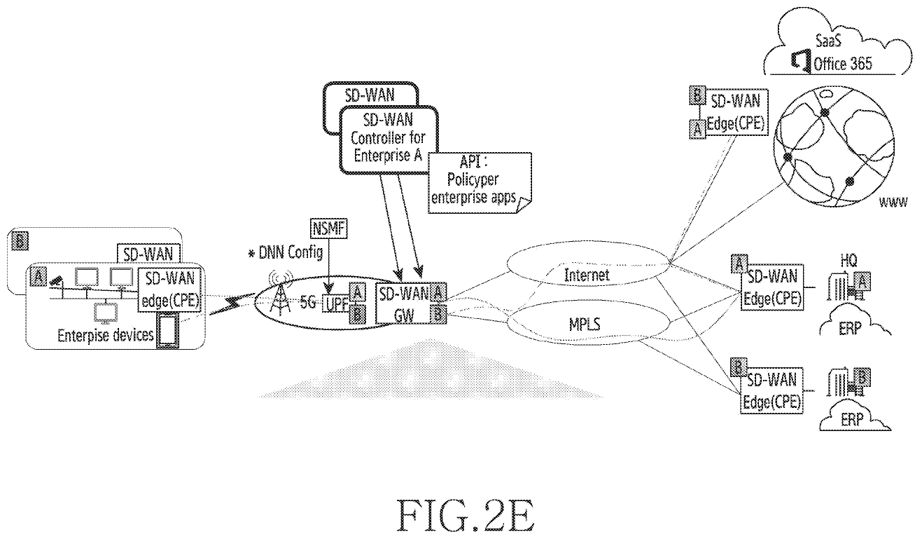

FIG. 2A illustrates a network structure for configuring a software defined wide area network (SD-WAN) according to an embodiment of the disclosure.

The network structure of FIG. 2A is a part of network nodes, and includes an integrated controller 201, a network slice management function (NSMF) 203, an SD-WAN controller 205, a software defined network controller (SDN-C) 207, SD-WAN edges 209, 213, and 215, and an SD-WAN gateway (GW) 211.

Referring to FIG. 2A, an Internet protocol security (IPsec) tunnel between the SD-WAN edge 209 and the SD-WAN GW 211 and an IPsec tunnel between the SD-WAN GW 211 and the SD-WAN edge 213 or 215 may be provided. Also, the IPsec tunnel between the SD-WAN edge 209 and the SD-WAN edge 213 or 215 may be provided.

According to an embodiment, the SD-WAN controller 205 may set a centralized policy and a local policy to the SD-WAN edges 209, 213, and 215 and/or the SD-WAN GW 211. The centralized policy may be divided into a control policy and a data policy. The control policy relates to the routing of an SD-WAN network, and may include the setting of an interface of an underlay network (wide area network (WAN)/local area network (LAN)), the selecting of a path for delivering packets to a destination address, routing for path optimization, load balancing, failover setting, service chaining, or a combination thereof. Based on the service chaining, it is possible to satisfy performance acceleration and security requirements by presenting a continuous path for one or more services. Also, a combination of service chaining may include not only the contents mentioned above but also various functions required in a network. The data policy relates to a traffic flow and security (e.g., IPsec, firewall, and filtering) of a data path, and may include path/flow security setting (e.g., IPsec key management, user authentication, and device identification), SLA setting of an application for a flow, telemetry setting for a flow, or a combination thereof. The local policy may be divided into a local control policy and a local data policy. The local control policy may be a routing protocol (e.g., open shortest path first (OSPF), and border gateway protocol (BGP)) for a site-local address. The local data policy may include L2 to L4 access control lists (ACLs) for controlling packets, a quality of service (QoS), traffic mirroring, or a combination thereof. According to an embodiment, the SD-WAN controller 205 may set a policy for matching between an application and a slice to the SD-WAN edges 209, 213, and 215 and the SD-WAN GW 211. The policy set to the SD-WAN edges 209, 213, 215 and the SD-WAN GW 211 may include a slice configuration, a classification configuration, a mapping policy, a forwarding profile, a gateway routing policy, an access control list policy, or a combination thereof. The slice configuration may include an underlay type (e.g., 5G slice, virtual private network (VPN), and Internet), a slice type (e.g., single-network slice selection assistance information (S-NSSAI)), a slice SLA (e.g., bandwidth, delay, and jitter), a slice tag, an access configuration between a UPF and an SD-WAN GW, a routing protocol type for each slice, a quota for each slice, or a combination thereof. The classification configuration may include a signature for each slice, a signature for each application, a source IP address and port, a destination IP address and port, a differentiated service code point (DSCP) field, a protocol, or a combination thereof. According to an embodiment, the mapping policy may include an application list for slices, a slice list for applications, or a combination thereof. The forwarding profile may include a flow type for each slice, an SLA, traffic shaping, a rate limit, queuing differentiation, or a combination thereof. The routing policy may include a data network path for a slice routing policy in downstream, a data network path for a 5G path in downstream, a slice for a data network path policy in upstream, a 5G path for a data network path in upstream, or a combination thereof. The access control list policy may include filtering rules for packets transmitted from a slice to a data network (e.g., Internet, and MPLS), filtering rules for packets transmitted from the data network (e.g., Internet, and MPLS) to the slice, or a combination thereof. According to an embodiment, the SD-WAN controller 205 may set a policy for security for each slice, service chaining for each slice, local breakout (LBO) for each slice, or a combination thereof to the SD-WAN GW 211.

According to an embodiment, the SD-WAN edge 209 may receive packets from an enterprise branch. The SD-WAN edge 209 may identify an application, based on the received packets. The SD-WAN edge 209 may add metadata to the received packets, based on SLA requirements of the identified application, and encapsulate them. The SD-WAN edge 209 may transmit the encapsulated packets by a slice that guarantees an SLA corresponding to the SLA requirements of the identified application. When there is no slice defined for the application, the SD-WAN edge 209 may add metadata about a default slice to the received packets, and encapsulate them. In this case, the SD-WAN edge 209 may transmit the encapsulated packets through the default slice.

According to an embodiment, the SD-WAN GW 211 may receive packets from a user plane function (UPF). The SD-WAN GW 211 may identify a slice through which the packets are transmitted, based on a transport IP address of the UPF or metadata included in the packets. The SD-WAN GW 211 may identify a path in a data network section, based on information (e.g., SLA of the slice) of the identified slice and the metadata. The SD-WAN GW 211 may transmit packets by the identified path (e.g., Internet or MPLS).

According to an embodiment, the SD-WAN edge 213 or 215 receiving packets may identify a specific site of an internal network. The SD-WAN edge 213 or 215 may transmit the received packets to the specific site of the internal network.

Referring to the above description, by transmitting packets through a slice in a wireless network capable of satisfying the SLA requirements for each application and a path in a data network, it is possible to guarantee an end-to-end SLA from a source (e.g., an enterprise branch) initially transmitting the packets to a target (e.g., a data center, and a headquarter (HQ)) finally receiving the packets.

Meanwhile, the SD-WAN edges 209, 213, and 215 and the SD-WAN GW 211 shown in FIG. 2A include all physical, logical, and virtual devices. For example, an SD-WAN function may be installed even as software in a mobile device.

Also, in FIG. 2A, the SD-WAN edges 213 and 215 on a data network side are shown as two, but this is only an example. Also, a data center and an HQ are shown as an internal network of the SD-WAN edges 213 and 215, but this is also only an example.

FIG. 2B illustrates a network structure for configuring a software defined wide area network (SD-WAN) according to an embodiment of the disclosure.

Referring to FIG. 2B, since the SD-WAN edge 209 is replaced with a legacy customer premise equipment (CPE) 217 (or is a general device without an SD-WAN client), only an Internet protocol security (IPsec) tunnel between the SD-WAN GW 211 and the SD-WAN edge 213 or 215 may be provided. According to an embodiment, in the case of uplink, the SD-WAN GW 211 may identify slice information, based on a source IP address of packets received from a user plane function (UPF) and port information. The SD-WAN GW 211 may identify a path in a data network section, based on the identified slice information. The SD-WAN GW 211 may transmit packets through the identified path (e.g., the Internet or multiprotocol label switching (MPLS). According to an embodiment, in the case of downlink, the SD-WAN GW 211 may identify slice information, based on a destination IP address of packets received from a data network, port information or metadata. The SD-WAN GW 211 may identify a slice to transmit packets, based on the identified slice information. The SD-WAN GW 211 may transmit the packets by the identified slice.

FIG. 2C illustrates a network structure for configuring a software defined wide area network (SD-WAN) according to an embodiment of the disclosure.

Referring to FIG. 2C, an Internet protocol security (IPsec) tunnel between the SD-WAN edge 209 and the SD-WAN edge 213 or 215 may be provided. In this case, slice selection is possible by the SD-WAN edge 213, but since there is no SD-WAN gateway (GW), path selection in a data network after a user plane function (UPF) is impossible, so true end-to-end SLA presenting is impossible.

FIG. 2D illustrates a network structure for configuring a software defined wide area network (SD-WAN) according to an embodiment of the disclosure.

Referring to FIG. 2D, according to an embodiment, the SD-WAN edge 209 may receive packets from an enterprise branch. The SD-WAN edge 209 may identify an application, based on the received packets. The SD-WAN edge 209 may add metadata to the received packets and encapsulate them, based on the service level agreement (SLA) requirements of the identified application. The SD-WAN edge 209 may transmit the encapsulated packets by a slice that guarantees an SLA corresponding to the SLA requirements of the identified application. When there is no slice defined for the application, the SD-WAN edge 209 may add metadata about a default slice to the received packets and encapsulate them. In this case, the SD-WAN edge 209 may transmit the encapsulated packets through the default slice.

According to an embodiment, the SD-WAN GW 211 may receive packets from a user plane function (UPF). The SD-WAN GW 211 may identify a slice through which a packet is transmitted, based on a transport Internet protocol (IP) address of a UPF, port information, or metadata included in the packets. The SD-WAN GW 211 may identify a path in a data network section, based on information (e.g., SLA of the slice) of the identified slice and metadata. The SD-WAN GW 211 may transmit packets to the identified path (e.g., Internet or multiprotocol label switching (MPLS)). The identified path may be a path that guarantees the SLA requirements of the application.

According to an embodiment, an SD-WAN GW 219 may receive packets from a data network. The SD-WAN GW 219 may identify a slice through which a packet is to be transmitted, based on a destination IP address, port information, or metadata included in the packets. The SD-WAN GW 219 may transmit the packets by the identified slice. The identified slice may be a path that guarantees the SLA requirements of the application.

According to an embodiment, an SD-WAN edge 221 receiving the packets may identify a specific site of an internal network. The SD-WAN edge 221 may transmit the received packets to the specific site of the internal network.

As described above, a link packet may be transmitted through a wireless network, a data network, and a 5G network. However, embodiments of the disclosure are not limited thereto. That is, the embodiments of the disclosure may be applied to all network structures in which the SD-WAN edge maps packets to a slice and the SD-WAN GW maps a slice in a wireless network and a path in a data network.

Meanwhile, although only the SD-WAN edge 221 is shown in FIG. 2D, the SD-WAN edges 213 and 215 may be connected to the data network as shown in FIGS. 2A to 2C.

FIG. 2E illustrates a network structure for configuring an SD-WAN according to an embodiment of the disclosure.

Referring to FIG. 2E, to support multi-tenancy, the SD-WAN gateway (GW) 211 may be configured as independent hardware equipment. Also, the SD-WAN GW 211 may be also configured as virtualization software for each tenancy in one equipment.

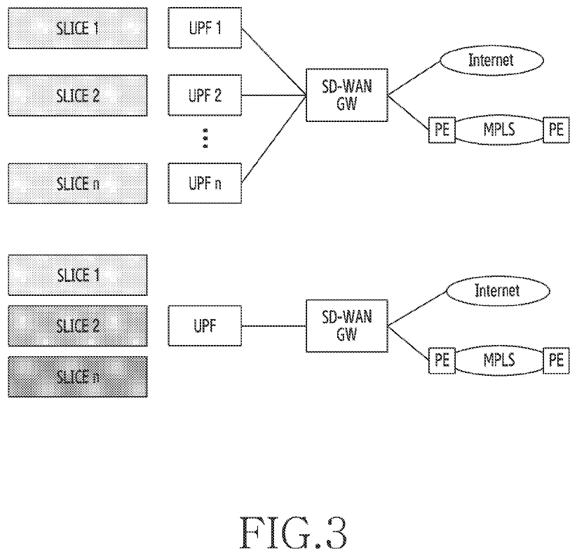

FIG. 3 illustrates a connection structure between a user plane function (UPF) and slices according to an embodiment of the disclosure.

FIG. 3 describes a process in which an SD-WAN gateway (GW) identifies slice information according to the number of slices connected to the user plane function (UPF).

Referring to FIG. 3, when the number of slices connected to the UPF is one, an SD-WAN GW 211 may identify slice information, based on an Internet protocol (IP) address of the UPF or metadata.

According to an embodiment, when there is not the SD-WAN edge 209 (see FIG. 2B), the SD-WAN GW 211 may identify information of a slice through which an uplink packet is transmitted, based on a source IP address. The above-described embodiment may be summarized as follows. The uplink packet received by the SD-WAN GW 211 may distinguish the slice information by the source IP address.

According to an embodiment, when there is not the SD-WAN edge 209 (see FIG. 2B), the SD-WAN GW 211 may identify information of a slice through which a downlink packet is to be transmitted, based on a destination IP address or metadata. The above-described embodiment may be summarized as follows. The downlink packet received by the SD-WAN GW 211 may distinguish the slice information by the destination IP address or an identified application identification (ID).

According to an embodiment, when there is the SD-WAN edge 209 (see FIG. 2A), the SD-WAN GW 211 may identify information of a slice through which an uplink packet is transmitted, based on a source IP address or metadata included in the uplink packet. The above-described embodiment may be summarized as follows. The uplink packet received by the SD-WAN GW 211 may distinguish the slice information by the source IP address, and may distinguish the slice information by the metadata such as slice identification (ID)/application ID/tenancy ID, etc.

According to an embodiment, when there is the SD-WAN edge 209 (see FIG. 2A), the SD-WAN GW 211 may identify information of a slice through which a downlink packet is to be transmitted, based on a destination IP address or metadata included in the downlink packet. The above-described embodiment may be summarized as follows. The downlink packet received by the SD-WAN GW 211 may distinguish the slice information by the destination IP address, and may also distinguish the slice information by the metadata such as slice ID/application ID/tenancy ID, etc.

When the number of slices connected to the UPF is plural, the SD-WAN GW 211 may identify slice information, based on an IP address or metadata.

According to an embodiment, when there is not the SD-WAN edge 209 (see FIG. 2B), the SD-WAN GW 211 may identify information of a slice through which an uplink packet is transmitted, based on a source IP address, port information, and an IP address pool. The IP address pool of an electronic device may be differently allocated for each slice by a dynamic host configuration protocol (DHCP) server. The SD-WAN GW 211 may identify the information of the slice through which the uplink packet is transmitted, based on the IP address pool to which the source IP address of the uplink packet belongs. The above-described embodiment may be summarized as follows. When the DHCP server of the UPF/SMF differently allocates the IP address pool of the device for each slice and provides corresponding information by a slice and then an NSMF informs this to the SD-WAN controller 205 (or the NSMF may inform the SD-WAN controller 205 through an integrated controller), the uplink packet received by the SD-WAN GW 211 may distinguish the slice information after which slice the source IP address of the uplink packet received by the SD-WAN GW 211 belongs to an IP address pool allocated to is checked. When a network address translation (NAT) is used, it cannot be distinguished since all of source IP addresses of the uplink packet received by the SD-WAN GW 211 are IP addresses of the UPF or NAT (or IP addresses of a device performing an equivalent function). In this case, the UPF or NAT may deliver information (i.e., port information) mapped to a corresponding device IP to the SD-WAN GW 211, and the SD-WAN GW 211 may know which slice the uplink packet belongs to, by the mapping information. Or, metadata provided based on a slice distinguished by the device IP and the port information before the NAT may be added to the uplink packet, whereby a routing function in the GW after the NAT may select a path, based on the metadata of the uplink packet.

According to an embodiment, when there is not the SD-WAN edge 209 (see FIG. 2B), the SD-WAN GW 211 may identify information of a slice through which a downlink packet is to be transmitted, based on a destination IP address, port information, and an IP address pool. The IP address pool of an electronic device may be differently allocated for each slice by the DHCP server. The SD-WAN GW 211 may identify the information of the slice through which the downlink packet is to be transmitted, based on the IP address pool to which the destination IP address of the downlink packet belongs. The above-described embodiment may be summarized as follows. When the DHCP server differently allocates an IP address pool of a device for each slice and provides corresponding information through a slice and then an NSMF informs this the SD-WAN controller 205, the downlink packet received by the SD-WAN GW 211 may distinguish the slice information after which slice the destination IP address of the downlink packet received by the SD-WAN GW 211 belongs to an IP address pool allocated to is checked. Alternatively, the NAT may identify which UPF is matched, based on information (i.e., port information) mapped to a corresponding destination IP, and the UPF may identify a slice through which the downlink packet is to be transmitted. Alternatively, metadata provided based on application information is added to the downlink packet before the NAT, whereby a routing function in the GW after the NAT may select a slice, based on the metadata of the downlink packet.

According to an embodiment, when there is not the SD-WAN edge 209 (see FIG. 2B), the SD-WAN GW 211 may identify information of a slice through which an uplink packet is transmitted, based on information (e.g., port information) mapped to an IP of an electronic device from a network address translation (NAT). The above-described embodiment is summarized as follows. When the NAT is used, a source IP address of the uplink packet received by the SD-WAN GW 211 cannot be distinguished. In this case, the NAT may deliver information (e.g., port information) mapped to a corresponding device IP to the SD-WAN GW 211, and the SD-WAN GW 211 may identify which slice the uplink packet belongs to, by the mapping information. Or, the NAT may deliver the information (i.e., port information) mapped to the corresponding device IP to a user plane function (UPF), and the UPF may identify which slice the uplink packet belongs to, based on the mapping information.

According to an embodiment, when there is not the SD-WAN edge 209 (see FIG. 2B), the SD-WAN GW 211 may identify information of a slice through which a downlink packet is to be transmitted, based on information (e.g., port information) mapped to an IP of an electronic device from an NAT. The above-described embodiment is summarized as follows. When the NAT is used, a source IP address of the downlink packet received by the SD-WAN GW 211 cannot be distinguished. In this case, the NAT may identify a matched UPF, based on the information (i.e., port information) mapped to the corresponding destination IP, and the UPF may identify a slice through which the downlink packet is to be transmitted.

According to an embodiment, when there is not the SD-WAN edge 209 (see FIG. 2B), the SD-WAN GW 211 may identify information of a slice through which a downlink packet is to be transmitted, based on application information. The above-described embodiment is summarized as follows. The SD-WAN GW 211 may identify application and tenancy IDs, based on the received downlink packet, provide a related signature, and transmit packets classified by the signature to the slice, based on the slice and related information (IP and port information) on the provided signature given by a policy.

According to an embodiment, when there is the SD-WAN edge 209 (see FIG. 2A), the SD-WAN GW 211 may identify information of a slice through which an uplink packet is transmitted, based on metadata included in the uplink packet. Summarizing the above-described embodiment, the slice information may be distinguished by metadata of the uplink packet received by the SD-WAN GW 211, such as slice ID/application ID/tenancy ID, etc.

According to an embodiment, there is the SD-WAN edge 209 (see FIG. 2A), the SD-WAN GW 211 may identify information of a slice through which a downlink packet is to be transmitted, based on metadata included in the downlink packet. Summarizing the above-described embodiment, the slice information may be distinguished by metadata of the downlink packet received by the SD-WAN GW 211, such as slice ID/application ID/tenancy ID, etc.

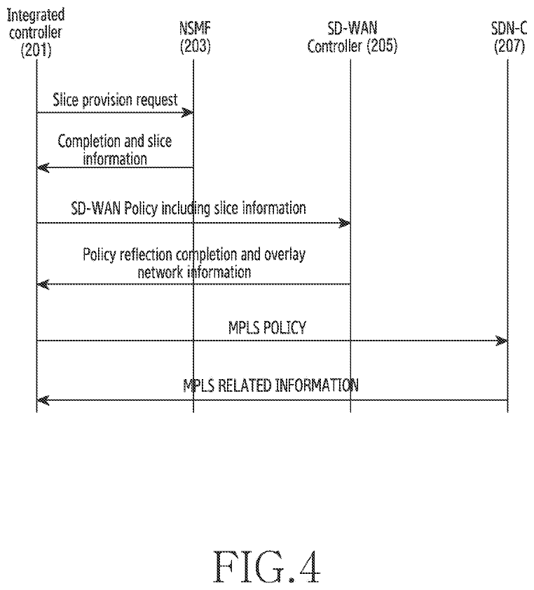

FIG. 4 illustrates a signal flow between network nodes for network control according to an embodiment of the disclosure.

Referring to FIG. 4, a method in which the integrated controller 201 controls a network slice management function (NSMF) 203, a software defined wide area network (SD-WAN) controller 205, and a software defined network controller (SDN-C) 207 is described.

The integrated controller 201 may transmit information required for slice provision to the NSMF 203. The information required for the slice provision may include the service level agreement (SLA) requirements of a slice, a slice ID, or a combination thereof. The SLA requirements of the slice may be prepared by a user or a communication service provider through an operation support system (OSS)/business support system (BSS). The integrated controller 201 may receive a user plane function (UPF) Internet protocol (IP) address of the slice, information on an IP address pool belonging to the slice, or a combination thereof, from the NSMF 203.

The integrated controller 201 may transmit a policy for SD-WAN devices to the SD-WAN controller 205. The policy for the SD-WAN devices may include the SLA requirements of an application, the SLA requirements of a data network, an application ID, a slice attribute, a mapped slice ID, or a combination thereof. The SLA requirements of the application and the SLA requirements of the data network may be prepared by the user or the communication service provider through the OSS/BSS. The integrated controller 201 may also transmit a UPF IP address of the slice, information on an IP address pool belonging to the slice, or a combination thereof to the SD-WAN controller 205. The integrated controller 201 may receive policy reflection completion and overlay network information from the SD-WAN controller 205. Also, when a path setting meeting the SLA requirements is completed, the integrated controller 201 may transmit SLA path setting completion and related information to the OSS/BSS.

The integrated controller 201 may transmit an MPLS policy to the SDN-C 207. The MPLS policy may include a VLAN ID for VRF provision, a VxLAN ID for VRF provision, data network SLA requirements, an application ID, or a combination thereof. The data network SLA requirements may be prepared by the user or communication service provider through the OSS/BSS. The integrated controller 201 may receive MPLS related information from the SDN-C 207.

Meanwhile, in FIG. 4, the integrated controller 201 is shown to control the NSMF 203, the SD-WAN controller 205, and the SDN-C 207 in this order, but this is only an example, and may be controlled in any order.

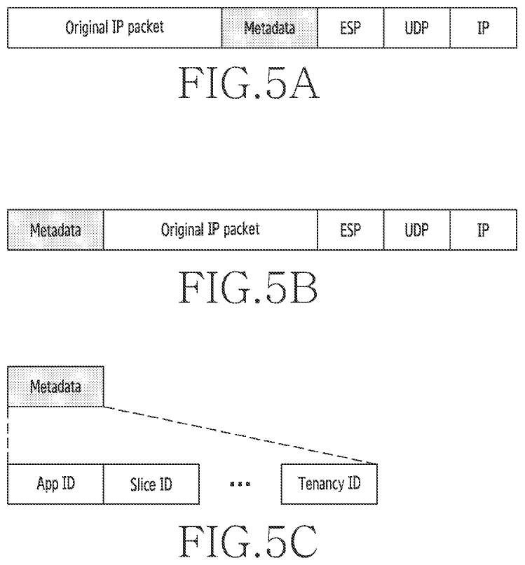

FIGS. 5A, 5B, and 5C illustrate a construction of a packet according to various embodiments of the disclosure.

Referring to FIGS. 5A and 5B, as a construction of packets, an original IP packet, metadata, an encapsulating security payload (ESP) header, a user datagram protocol (UDP) header, and an Internet protocol (IP) header are exemplified. Since a packet transmitted from a software defined wide area network (SD-WAN) edge uses an IP security (IPsec) tunnel, the packet may be constructed as an IPsec packet. A packet encapsulated with IPsec may be constructed by adding metadata. Since the packet constructed by adding the metadata is not constructed in compliance with a standard method, the packet may be dropped or misrecognized according to router equipment. Therefore, the packet may be constructed like a normal UDP packet that may pass through a router by using UDP encapsulation. The UDP encapsulation may be encapsulation by adding the UDP header before the ESP header. Meanwhile, according to an embodiment, metadata may be added between the original IP packet and the ESP header (see FIG. 5A). According to another embodiment, metadata may be added to a tail of the packet (see FIG. 5B). When the metadata is added to the tail of the packet, less processing power may be consumed in terms of packet processing. According to a further embodiment, although not shown, metadata may be placed in an arbitrary position of the packet. The location of the metadata within the packet may be determined by the SD-WAN controller, the SD-WAN edge, or the integrated controller. In this case, the network node having determined the location of the metadata within the packet may inform the location of the metadata within the packet to other network nodes (e.g., the SD-WAN edge, the SD-WAN GW, etc.).

Referring to FIG. 5C, metadata may include an application ID for classifying applications, a slice ID for classifying slice information (e.g., network slice selection assistance information (S-NSSAI)), a tenancy ID for classifying tenancy, or a combination thereof. The application ID may consist of 2 bytes, the slice ID may consist of 2 bytes, and the tenancy ID may consist of 4 bytes, but this is just an example, and may be defined in various sizes. Since the size of the metadata varies depending on information included in the metadata, and the network node (e.g., SD-WAN gateway (GW)) receiving a packet including the metadata must be able to know a construction of the packet, the SD-WAN controller may preset information included in the packet transmitted by the SD-WAN edge.

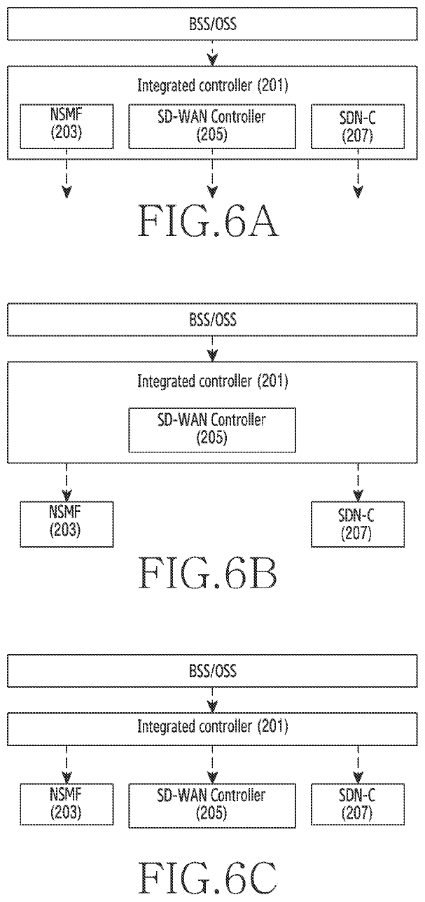

FIGS. 6A, 6B, and 6C illustrate a structure of an integrated controller for network control according to various embodiments of the disclosure. FIGS. 6A to 6C illustrate an operation support system (OSS)/business support system (BSS) capable of being set by a user or a communication service provider, a network slice management function (NSMF) 203 of controlling a network slice, an SD-WAN controller 205 of controlling a software defined network (SD-WAN) edge and gateway (GW), a software defined network controller (SDN-C) 207 for multiprotocol label switching (MPLS) control of a data network, and an integrated controller 201 of integrally controlling the NSMF 203, the SD-WAN controller 205 and the SDN-C 207. Here, the integrated controller 201 may be referred to as a broker.

Referring to FIGS. 6A to 6C, since the NSMF 203, the SD-WAN controller 205 and the SDN-C 207 may be equipment of different communication service providers, the user or communication service provider may control the NSMF 203, the SD-WAN controller 205 and the SDN-C 207 through the integrated controller 201. According to an embodiment, the NSMF 203, the SD-WAN controller 205 and the SDN-C 207 may be included and constructed in the integrated controller 201 (see FIG. 6A). According to an embodiment, at least one of the NSMF 203, the SD-WAN controller 205 and the SDN-C 207 may be included and constructed in the integrated controller 201 (see FIG. 6B). According to an embodiment, the NSMF 203, the SD-WAN controller 205 and the SDN-C 207 may be configured separately from the integrated controller 201, and may be also controlled only by the integrated controller 201 (see FIG. 6C).

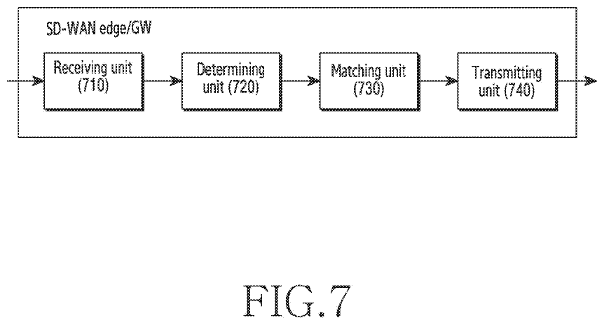

FIG. 7 illustrates a construction of a software defined wide area network (SD-WAN) device according to an embodiment of the disclosure. The construction illustrated in FIG. 7 may be understood as a construction of the SD-WAN edges 209, 213 and 215 and the SD-WAN GW 211 of FIG. 2A.

Referring to FIG. 7, the SD-WAN device may include a receiving unit 710, a determining unit 720, a matching unit 730, and a transmitting unit 740.

The SD-WAN edge 209 may include the receiving unit 710, the determining unit 720, the matching unit 730, and the transmitting unit 740. According to an embodiment, in uplink transmission, the receiving unit 710 may receive packets from an enterprise branch. The determining unit 720 may identify application information of the received packets. The matching unit 730 may identify a slice corresponding to an application, based on the identified application information. The transmitting unit 740 may add metadata about the identified slice to the packets, encapsulate the packets, and transmit the encapsulated packets to the identified slice. According to an embodiment, in downlink transmission, the receiving unit 710 may receive packets from a wireless network. The determining unit 720 may identify slice information of the received packets. The matching unit 730 may identify an application corresponding to a slice, based on the identified slice information. The transmitting unit 740 may remove metadata from the received packets, decapsulate the encapsulation, and transmit the packets to the identified application destination.

The SD-WAN GW 211 may include the receiving unit 710, the determining unit 720, the matching unit 730, and the transmitting unit 740. According to an embodiment, in uplink transmission, the receiving unit 710 may receive packets from a user plane function (UPF). The determining unit 720 may identify slice information, based on metadata of the received packets. The matching unit 730 may identify a path in a data network section, based on the identified slice information. The transmitting unit 740 may transmit the packets through the identified path. According to an embodiment, in downlink transmission, the receiving unit 710 may receive packets from a data network. The determining unit 720 may identify application information of the received packets. The matching unit 730 may identify a slice corresponding to an application, based on the identified application information. The transmitting unit 740 may transmit the packets through the identified slice.

In supporting multiple tenancies, the SD-WAN GW 211 may include the receiving unit 710, the determining unit 720, the matching unit 730, and the transmitting unit 740. According to an embodiment, in uplink transmission, the receiving unit 710 may receive packets from a wireless network. The determining unit 720 may identify slice information of the received packets. The matching unit 730 may determine a tenancy mapped to the identified slice, and determine a path in a data network section, based on a policy for each determined tenancy. The transmitting unit 740 may transmit packets through the determined path in consideration of a quality of service (QoS) and transmission control for each tenancy. According to an embodiment, in downlink transmission, the receiving unit 710 may receive packets from a data network. The determining unit 720 may identify tenancy information of the received packets. The matching unit 730 may determine a slice, based on a policy for each identified tenancy. The transmitting unit 740 may transmit the packets through the determined slice in consideration of a QoS and transmission control for each tenancy.

In supporting an application for each of multiple tenancies, the SD-WAN GW 211 may include the receiving unit 710, the determining unit 720, the matching unit 730, and the transmitting unit 740. According to an embodiment, in uplink transmission, the receiving unit 710 may receive packets from a wireless network. The determining unit 720 may identify slice and application information of the received packets. The matching unit 730 may determine tenancy mapped to the identified slice, and determine a path in a data network section, based on a policy for each application of the determined tenancy. The transmitting unit 740 may transmit the packets through the determined path in consideration of a QoS and transmission control for each tenancy. According to an embodiment, in downlink transmission, the receiving unit 710 may receive packets from a data network. The determining unit 720 may identify application and tenancy information of the received packets. The matching unit 730 may determine a slice, based on a policy for each application of the identified tenancy. The transmitting unit 740 may transmit the packets through the determined slice in consideration of a QoS and transmission control for each tenancy.

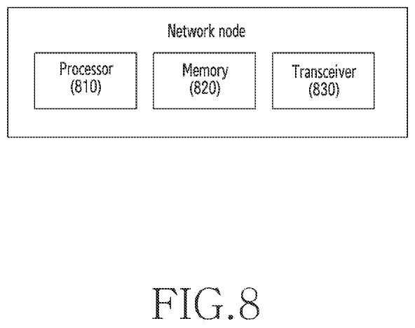

FIG. 8 illustrates a construction of network nodes according to an embodiment of the disclosure. The construction illustrated in FIG. 8 may be understood as the construction of network nodes exemplified in FIG. 2A.

Referring to FIG. 8, the network nodes may include a processor 810, a memory 820, and a transceiver 830.

The processor 810 controls the overall operation of the network node. For example, the processor 810 may transmit and receive signals through the transceiver 830. Also, the processor 810 may write data to and read data from the memory 820. And, the processor 810 may perform functions of a protocol stack required by communication standards. To this end, the processor 810 may include at least one processor. According to various embodiments, the processor 810 may control the network node to perform operations of the above-described embodiments.

The memory 820 may store data such as a basic program for operation of the network node, an application program, setting information, and the like. The memory 820 may be composed of a volatile memory, a non-volatile memory, or a combination of volatile and non-volatile memories. Also, the memory 820 may provide stored data according to a request of the processor 810.

The transceiver 830 may perform functions for transmitting and receiving signals through a wireless channel. For example, the transceiver 830 may perform a conversion function between a baseband signal and a bit stream according to the physical layer standard of a system. For example, when transmitting data, the transceiver 830 may provide complex symbols by encoding and modulating a transmission bit stream. Also, when receiving data, the transceiver 830 may restore a received bit stream by demodulating and decoding a baseband signal. Also, the transceiver 830 may up convert a baseband signal into a radio frequency (RF) band signal and transmit the signal through an antenna, and down covert an RF band signal received through the antenna into a baseband signal. The transceiver 830 may provide an interface for communicating with other nodes in a network. That is, the transceiver 830 may convert a bit stream transmitted to another network node into a physical signal, and convert a physical signal received from another node into a bit stream. The transceiver 830 may include at least one transceiver for this purpose.

Through FIGS. 1, 2A to 2E, 3, 4, 5A to 5C, 6A to 6C, 7 and 8, a technology for guaranteeing an end-to-end service level agreement (SLA) has been described. In the legacy software defined wide area network (SD-WAN), network path selection was possible, but slice selection was impossible because a wireless network was treated as only one connectivity. That is, SLA guarantee within the wireless network was difficult. Therefore, by interlocking network slicing allowing SLA guarantee in the wireless network to the SD-WAN, embodiments of the disclosure may map a packet, a slice, and a data network path, based on the SLA requirements for each application, an SLA for each slice, and an SLA for each data network path, and make it possible to guarantee a true end-to-end SLA.

A method performed by a first network node of an embodiment of the disclosure described above may include the operations of receiving a packet from a user plane function (UPF), identifying a path of a data network, based on information included in the packet, and transmitting the packet through the path of the data network.

According to an embodiment, the information included in the packet may include at least one of a slice identification (ID), an application ID, a tenancy ID, and a transport Internet protocol (IP) address of the UPF.

According to an embodiment, a service level agreement (SLA) of a slice through which the packet is transmitted may correspond to an SLA of the path of the data network.

According to an embodiment, the operation of identifying the path of the data network based on the information included in the packet may include the operations of identifying a slice through which the packet is transmitted, based on the information included in the packet, and identifying the path of the data network corresponding to the identified slice, based on a mapping policy.

According to an embodiment, the operation of identifying the path of the data network based on the information included in the packet may include the operations of identifying a transport Internet protocol (IP) address of a user plane function (UPF) included in the packet, identifying a slice through which the packet is transmitted, based on the transport IP address, and identifying the path of the data network corresponding to the identified slice, based on a mapping policy.

According to an embodiment, the operation of identifying the path of the data network may include the operations of identifying a slice through which the packet is transmitted, based on the information included in the packet, identifying a tenancy mapped to the identified slice, and identifying the path of the data network, based on a policy for each the identified tenancy.

According to an embodiment, the method may include the operations of receiving a packet from the data network, identifying an application, based on information included in the received packet, identifying a slice corresponding to the identified application, and transmitting the packet through the identified slice.

A method performed by a second network node of an embodiment of the disclosure described above may include the operations of receiving a packet from a device, identifying an application of the received packet, identifying a slice through which the identified application is to be transmitted, and transmitting the packet through the identified slice.

According to an embodiment, the operation of identifying the slice may include the operations of identifying the service level agreement (SLA) requirements of the application, and identifying the slice, based on the SLA requirements.

According to an embodiment, the method may include the operation of adding information on an identification (ID) of the slice, an application ID, a tenancy ID, or a combination thereof to the packet.

A first network node of an embodiment of the disclosure described above may include at least one transceiver, and at least one processor operatively connected to the at least one transceiver. The at least one processor may be configured to receive a packet from a user plane function (UPF), identify a path of a data network, based on information included in the packet, and transmit the packet through the path of the data network.

According to an embodiment, the information included in the packet may include at least one of a slice identification (ID), an application ID, a tenancy ID, and a transport Internet protocol (IP) address of the UPF.

According to an embodiment, a service level agreement (SLA) of a slice through which the packet is transmitted may correspond to an SLA of the path of the data network.

According to an embodiment, the at least one processor may be configured to identify a slice through which the packet is transmitted, based on the information included in the packet, and identify the path of the data network corresponding to the identified slice, based on a mapping policy.

According to an embodiment, the at least one processor may be configured to identify a transport Internet protocol (IP) address of a user plane function (UPF) included in the packet, identify a slice through which the packet is transmitted, based on the transport IP address, and identify the path of the data network corresponding to the identified slice, based on a mapping policy.

According to an embodiment, the at least one processor may be configured to identify a slice through which a packet is transmitted, based on information included in the packet, identify a tenancy mapped to the identified slice, and identify a path of the data network, based on a policy for each the identified tenancy.

According to an embodiment, the at least one processor may be configured to receive a packet from the data network, identify an application, based on information included in the received packet, identify a slice corresponding to the identified application, and transmit the packet through the identified slice.

A second network node of an embodiment of the disclosure described above may include at least one transceiver and at least one processor operably connected to the at least one transceiver. The at least one processor may be configured to receive a packet from a device, identify an application of the received packet, identify a slice through which the identified application is to be transmitted, and transmit the packet through the identified slice.

According to an embodiment, the at least one processor may be configured to identify the service level agreement (SLA) requirements of the application, and identify the slice, based on the SLA requirements.

According to an embodiment, the packet may include information on the slice identification (ID), the application ID, a tenancy ID, or a combination thereof.

Methods of embodiments described in the claims or specification of the disclosure may be implemented in the form of hardware, software, or a combination of hardware and software.

When it is implemented by software, a computer-readable storage medium storing one or more programs (software modules) may be presented. One or more programs stored in the computer-readable storage medium are configured for execution by one or more processors in an electronic device. The one or more programs include instructions that cause the electronic device to execute methods of embodiments described in the claims or specification of the disclosure.

Such programs (software modules, software) may be stored in a random access memory, a non-volatile memory including a flash memory, a read only memory (ROM), an electrically erasable programmable ROM (EEPROM), a magnetic disc storage device, a compact disc-ROM (CD-ROM), digital versatile discs (DVDs) or other optical storage devices, magnetic cassettes. Or, it may be stored in a memory composed of a combination of some or all of these. Also, each constructed memory may be included in multiple numbers.

Also, the program may be stored in an attachable storage device that may be accessed through a communication network such as the Internet, an intranet, a local area network (LAN), a wide area network (WAN), or a storage area network (SAN), or a communication network consisting of a combination thereof. Such a storage device may be connected to a device performing an embodiment of the disclosure through an external port. Also, a separate storage device on a communication network may be connected to a device performing an embodiment of the disclosure.

In specific embodiments of the disclosure described above, components included in the disclosure are expressed in singular or plural number according to the specific embodiments presented. However, the expression of the singular or plural number is selected appropriately for the presented situation for convenience of description, and the disclosure is not limited to singular or plural components, and even the component expressed in the plural number are composed of the singular number, or even the component expressed in the singular number may be composed of the plural number.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a first network node in a communication system, the method comprising:
receiving, from a user plane function (UPF), a first packet;
based on information comprised in the first packet, identifying a path of a data network; and
transmitting the first packet through the path of the data network.

2. The method of claim 1, wherein the information comprised in the first packet comprises at least one of a slice identification (ID), an application ID, a tenancy ID, or a transport Internet protocol (IP) address of the UPF.

3. The method of claim 1, wherein a service level agreement (SLA) of a slice through which the first packet is transmitted corresponds to an SLA of the path of the data network.

4. The method of claim 1, wherein the identifying of the path of the data network comprises:
based on the information comprised in the first packet, identifying a slice through which the first packet is transmitted; and
based on a mapping policy, identifying the path of the data network corresponding to the slice.

5. The method of claim 1, wherein the identifying of the path of the data network comprises:
identifying a transport Internet protocol (IP) address of the UPF comprised in the first packet;
based on the transport IP address, identifying a slice through which the first packet is transmitted; and
based on a mapping policy, identifying the path of the data network corresponding to the slice.

6. The method of claim 1, wherein the identifying of the path of the data network comprises:
based on the information comprised in the first packet, identifying a slice through which the first packet is transmitted;
identifying at least one tenancy mapped to the slice; and
based on a policy for each identified tenancy, identifying the path of the data network.

7. The method of claim 1, further comprising:
receiving a second packet from the data network;
based on information comprised in the second packet, identifying an application;
identifying a slice corresponding to the application; and
transmitting the second packet through the slice.

8. A method performed by a second network node in a communication system, the method comprising:
receiving, from a device, a packet;
identifying an application of the packet;
identifying a slice through which the application is to be transmitted; and
transmitting the packet through the slice.

9. The method of claim 8, wherein the identifying of the slice comprises:
identifying service level agreement (SLA) requirements of the application; and
based on the SLA requirements, identifying the slice.

10. The method of claim 8, further comprising:
adding information on an identification (ID) of the slice, an application ID, a tenancy ID, or a combination thereof to the packet.

11. A first network node in a communication system, the first network node comprising:
a transceiver; and
at least one processor connected with the transceiver,
wherein the at least one processor is configured to:
receive, from a user plane function (UPF), a packet,
based on information comprised in the packet, identify a path of a data network, and
transmit the packet through the path of the data network.

12. The first network node of claim 11, wherein the information comprised in the packet comprises at least one of a slice identification (ID), an application ID, a tenancy ID, or a transport Internet protocol (IP) address of the UPF.

13. The first network node of claim 11, wherein a service level agreement (SLA) of a slice through which the packet is transmitted corresponds to an SLA of the path of the data network.

14. The first network node of claim 11, wherein the at least one processor is further configured to:
based on the information comprised in the packet, identify a slice through which the packet is transmitted, and
based on a mapping policy, identify the path of the data network corresponding to the slice.

15. The first network node of claim 11, wherein the at least one processor is further configured to:
identify a transport Internet protocol (IP) address of the UPF comprised in the packet,
based on the transport IP address, identify a slice through which the packet is transmitted, and
based on a mapping policy, identify the path of the data network corresponding to the slice.

16. The first network node of claim 11, wherein the at least one processor is further configured to:
based on the information comprised in the packet, identify a slice through which the packet is transmitted,
identify at least one tenancy mapped to the slice, and
based on a policy for each identified tenancy, identify the path of the data network.

17. The first network node of claim 11, wherein the at least one processor is further configured to:
receive a second packet from the data network,
based on information comprised in the second packet, identify an application,
identify a slice corresponding to the application, and
transmit the second packet through the slice.

18. A second network node in a communication system, the second network node comprising:
a transceiver; and
at least one processor connected with the transceiver,
wherein the at least one processor is configured to:
receive, from a device, a packet,
identify an application of the packet,
identify a slice through which the application is to be transmitted, and
transmit the packet through the slice.

19. The second network node of claim 18, wherein the at least one processor is further configured to:
identify service level agreement (SLA) requirements of the application, and
based on the SLA requirements, identify the slice.

20. The second network node of claim 18, wherein the at least one processor is further configured to:
add information on an identification (ID) of the slice, an application ID, a tenancy ID, or a combination thereof to the packet.
